(19) United States
(12) Patent Application Publication
(10) Pub. No.: US 2016/0205727 A1
(43) Pub. Date: Jul. 14, 2016

(54) MICROFLUIDIC-BASED APPARATUS AND METHOD VAPORIZATION OF LIQUIDS USING MAGNETIC INDUCTION

(71) Applicant: Numerical Design, Inc., Santa Barbara, CA (US)

(72) Inventors: Carl D. Meinhart, Santa Barbara, CA (US); Brian Piorek, Santa Barbara, CA (US); Nicholas B. Judy, Santa Barbara, CA (US)

(73) Assignee: Numerical Design, Inc., Santa Barbara, CA (US)

(21) Appl. No.: 14/949,818

(22) Filed: Nov. 23, 2015

Related U.S. Application Data
(60) Provisional application No. 62/085,178, filed on Nov. 26, 2014.

(51) Int. Cl. H05B 6/10; H05B 1/02

(52) U.S. Cl. CPC H05B 6/108; H05B 1/0244; H05B 1/0202

(57) ABSTRACT

Methods and apparatus for vaporizing liquid into the surrounding environment, including directing liquid from a liquid source to a vaporization port where the vaporization port has lateral dimensions varying from 10 um to 300 um, by magnetically inductive heating a liquid in the vaporization port with an at least one inductive heating element located in thermal communication to the vaporization port, and releasing vaporized liquid from the vaporization port into the surrounding environment so that fluid is transported through the depth of the structure.

### CROSS-REFERENCE TO RELATED APPLICATIONS

This application claims priority to U.S. provisional Application; Ser. No. 62/085,178 filed Nov. 26, 2014, which is incorporated by reference in its entirety.

### BACKGROUND

This specification relates to an apparatus and methods for vaporizing liquids and in particular a vaporizer providing well-controlled spatial distributions of vapor, with controlled and accurate dosage of vapor, with well-controlled vaporization temperature profiles, and with high thermodynamic efficiency.

Vaporizers, such as e-cigarettes, humidifiers and other personal as well as medical vaporizers and fragrance vaporizers are becoming increasingly common. Many such vaporizers rely on techniques which have been prevalent for many years. Such vaporizers may benefit from new design approaches and modern fabrication capabilities.

### SUMMARY

In some embodiments an apparatus may be microfabricated using batch fabrication techniques, the devices can be manufactured to be nearly identical from device to device. Microfabrication allows the devices to be manufactured in large volumes with high unit-to-unit reproducibility and low per-unit cost.

In some embodiments, a vaporization apparatus may be provided that may be placed within a surrounding environment to vaporize liquid into the surrounding environment, including at least one liquid source, at least one vaporization port that may be formed in a structure, with lateral dimensions varying from 10 um to 300 um, that may be in fluid communication with the liquid source and the surrounding environment, and at least one inductive heating element that may be in thermal communication to the at least one vaporization port.

In some embodiments, electromagnetic induction can be used to heat a structure that can then vaporize a fluid.

In some embodiments, the fluid communication between the liquid source and the surrounding environment may occur throughout the depth of the apparatus, so that fluid is transported through the depth of the structure.

In some embodiments, the structure may include a thin structural region, with a thickness varying from 1 um to 100 um.

In some embodiments, a protective layer may be formed on the structure that surrounds the heating element.

In some embodiments, the protective layer may include deposited glass.

In some embodiments, a surface coating may be formed on the structure but may be masked from forming on the walls of the vaporization ports.

In some embodiments, the surface coating may include fluoropolymers.

In some embodiments, the surface coating may include silicon nitride.

In some embodiments, at least one of a bead or particle wicking structure may be located in at least one of the liquid source region(s) of the structure or within the ports.

In some embodiments, at least one of the beads or particles may have dimensions of 10 um to 300 um.

In some embodiments, at least one of the beads or particles may comprise a hydrophilic surface.

In some embodiments, at least one of the beads or particles may comprise a hydrophobic surface.

In some embodiments, at least one of the beads or particles may be sintered.

In some embodiments, at least one of the beads or particles are comprised of glass.

In some embodiments, the inductive heating element may be a thin-film resistive heating element.

In some embodiments, the resistances of the inductive heating elements may be varied to provide a controlled thermal distribution.

In some embodiments, the inductive heating elements may be electrically connected in parallel and series combination.

In some embodiments, a method may be provided for vaporizing liquid into the surrounding environment, including directing liquid from a liquid source to a vaporization port, wherein the vaporization port may have lateral dimensions varying from 10 um to 300 um, using magnetic induction to apply heat to the liquid in the vaporization port with at least one heating element located in close proximity (which could range between 5 um to 100 um, or 0.5 um to 1 mm) to the vaporization port, and releasing vaporized liquid from the vaporization port into the surrounding environment.

In some embodiments, during operation, liquid may continually flow from the liquid source to the vaporization port, may change phase from liquid to vapor, and the vapor may continuously flow from the vaporization port to the surrounding environment.

In some embodiments, fluid may flow through the depth of the structure from the liquid source to the surrounding environment.

In some embodiments, a thin structural region may substantially confine thermal energy to close proximity (which could range from 100 um to 10 mm, or 10 um to 100 mm) of or in contact with the at least one heating element and the at least one vaporization port.

In some embodiments, an inductive heating element is in contact with a thin structural region, wherein the thin structural region is in contact with liquid from a liquid source. The inductive heating element can heat the thin structural region, and the thin structural region can heat liquid, causing the liquid to vaporize.

In some embodiments, the thin structural region may reduce thermally-induced stresses that may occur in close proximity (which could range between 5 um to 100 um, or 0.5 um to 1 mm) to the at least one heating element and the at least one vaporization port. In some embodiments, it is desirable for the principal stress to be less than 10 -20 MPa. In some embodiments, it is desirable for the principal stress to be less than 70 MPa.

### BRIEF DESCRIPTION OF THE DRAWINGS

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the disclosure.

FIGS. 1A, 1B, 1C, 1D, and 1E show side views of the apparatus of an illustrative embodiment.

FIGS. 2A shows a side view and 2B shows a top view of the apparatus of an illustrative embodiment.

FIG. 3 shows a perspective view of an illustrative embodiment.

FIGS. 4A, 4B, 4C and 4D show side views depicting components of an illustrative embodiment.

FIG. 5 shows a side view depicting components of an illustrative embodiment.

FIG. 6 shows a side view depicting components of an illustrative embodiment.

FIGS. 7A and 7B show perspective views of an illustrative embodiment.

FIGS. 8A 8B, 8C and 8D show side views of an illustrative embodiment.

FIG. 9 shows a side view of an illustrative embodiment.

FIG. 10 shows a side view of the apparatus depicting illustrative temperature profiles and major components of an illustrative embodiment.

FIG. 11 shows a side view of the apparatus illustrating the motion of the fluid and major components of an illustrative embodiment.

FIG. 12 shows a side view of the apparatus illustrating the motion of the fluid and major components of an illustrative embodiment.

FIG. 13 shows a method for microfabricating an illustrative embodiment.

FIG. 14 is flowchart of a method for vaporizing liquid with a microfluidic chip according to an illustrative embodiment.

FIG. 15 is a flowchart of a method for vaporizing a chemical contained in a chemical capsule according to an illustrative embodiment.

### DETAILED DESCRIPTION

Generally described, aspects of the present disclosure relate to vaporizers produced using fine scale microfabrication techniques for both the structure and heating element. Microfabrication may include patterning, etching, deposition, injection and related processes on such materials as glass, metals, plastics and crystalline materials such as silicon and silicon derivatives. Heating elements may include inductively coupled magnetic heating elements. Heating elements may include electronic circuits made from electrical components including resistors, capacitors, transistors, logic element and the like which also may be fabricated onto application specific circuits and/or made up of discrete components in any combination.

One or more embodiments described herein may provide well-controlled heating, thus minimizing the effect of the liquid to become excessively hot, thus minimizing undesirable chemical reactions that produce undesirable and/or harmful chemical reaction products.

One or more embodiments described herein may provide vaporization devices manufactured in a highly controlled manner, thus reducing significant variation from unit to unit, and thereby reducing variation in performance.

One or more embodiments described herein may provide vaporizers which are thermodynamically efficient, and less bulky in size.

Microfluidic vaporizers disclosed here may be used to provide efficient vaporization of low-volatility liquids for a large range of applications, including fragrance distribution, medical vaporization, vaporized drug delivery, chemical distillation, chemical-reaction control, aromatics, waxes, scented waxes, air sterilization, theatrical smoke, fog machines, aroma therapy, essential oils, personal vaporizers, chemical vapor or aerosol detector calibration devices, smoking articles, and electronic cigarettes.

Vaporization devices are a general class of devices used to create vapors or aerosols from liquids. Vaporizers have many applications, including but not limited to: fragrance distribution, medical vaporization, vaporized drug delivery, chemical distillation, chemical-reaction control, aromatics, waxes, scented waxes, air sterilization, theatrical smoke, fog machines, aroma therapy, essential oils, personal vaporizers, smoking articles and electronic cigarettes, among others.

The present disclosure describes embodiments, where the vaporization device is microfabricated using modern microfabrication techniques, including lithography, deposition and etching techniques. Such techniques may be applied advantageously to vaporizer design. For example, an embodiment could have micron-scale precision components. In yet other embodiments, the disclosed apparatus and methods could be compatible with injection molded plastics. In an embodiment, the vaporization apparatus and method could have similar geometries from unit to unit. Furthermore, an embodiment could be produced at a low cost in high production volume.

Some embodiments disclosed herein may provide desirable performance improvements. For example in one embodiment, the micron-scale precision of the components allows for accurate dosing of a vaporized material, and precisely-controlled temperature, which can eliminate overheated regions that produce undesirable chemical reaction products. In additional embodiments, the apparatus can be designed to minimize parasitic heat transfer to the substrate, surrounding environment or interposer. In some embodiments, the apparatus can be made very small, planar and highly portable. The micron-scale features can improve the thermodynamic efficiency of the apparatus and method, and could have minimal energy requirements. In yet another embodiment, the vaporization ports could be individually addressed and activated in a controlled fashion, so that a chemical reaction front or precise release of particular chemicals based on time and individual position within the array of vaporization ports could be established.

In some embodiments magnetic induction heating could be used to vaporize the liquid. In magnetic induction heating, an alternating electrical current could flow through a driving circuit. The driving circuit could be a single turn coil or a multi-turn coil. Following Ampere's law, the alternating electrical current could induce an alternating magnetic field, according to

$$\overline{v} \times H = J + \frac{\partial D}{\partial t} , \qquad ( 1 )$$

where H is the magnetic field, J is the current density, and D is the electric displacement. The magnetic field H and magnetic density B are related through the constitutive equation, B=μᵣμ₀H, where μᵣ is the relative magnetic permeability, and μ₀ is the magnetic permeability of free space. Many materials have μᵣ=1. Many ferromagnetic materials can exhibit very large μᵣ, and in some cases could be much larger than 1, and could be characterized by a non-linear B-H curve.

Faraday's law of induction can be expressed as

$$\overline{v} \times E = - \frac{\partial B}{\partial t} , \qquad ( 2 )$$

where E is the induced electric field. A large time varying magnetic density field B can induce an electric field that induces current flow in an inductive heating element. Magnetic materials, such as ferromagnetic materials, could be advantageous for use in inductive heating elements, because a large oscillating magnetic density field B could be produced. The electric field in an inductive heating element could induce current through Ohm's law J=σE, where σ is the electrical conductivity. The current flow in an inductive heating element could induce Joule heating following

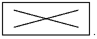

In addition, hysteresis in the B-H relationship could create heating in an inductive heating element.

In some embodiments, it could be advantageous to have the driving circuit in close proximity to the inductive heating element, so that the magnetic field can be closely coupled. In some embodiments, it could be advantageous to have the driving circuit to be of small lateral dimension, say 1 um to 300 um, or say 1 um to 1000 um, which could produce larger H for a given current. In some embodiments, it could be advantageous to have larger driving circuits, say 1 mm to 10 mm or even larger.

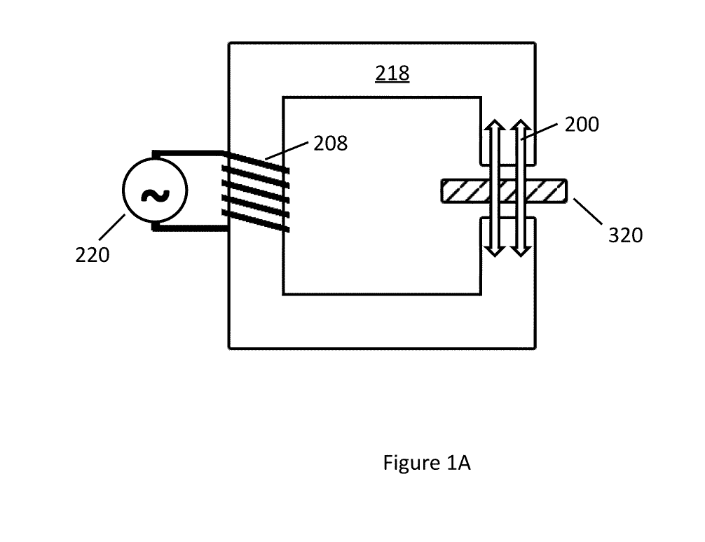

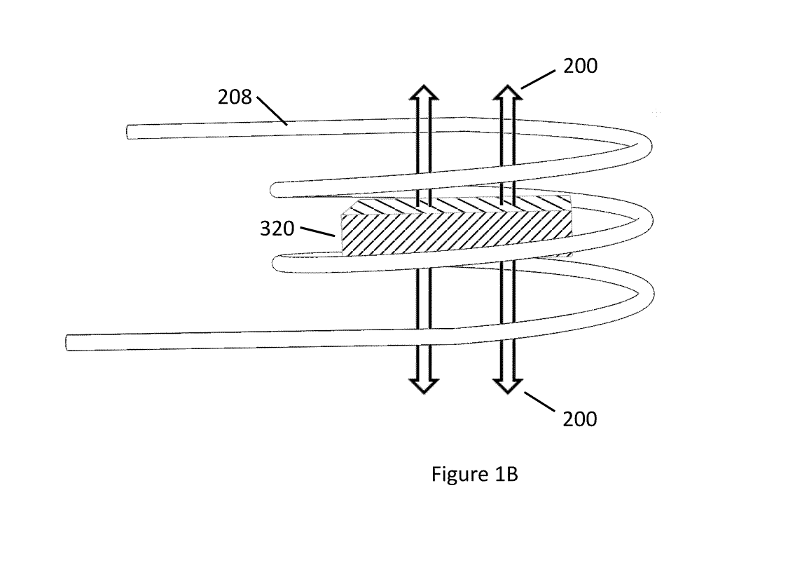

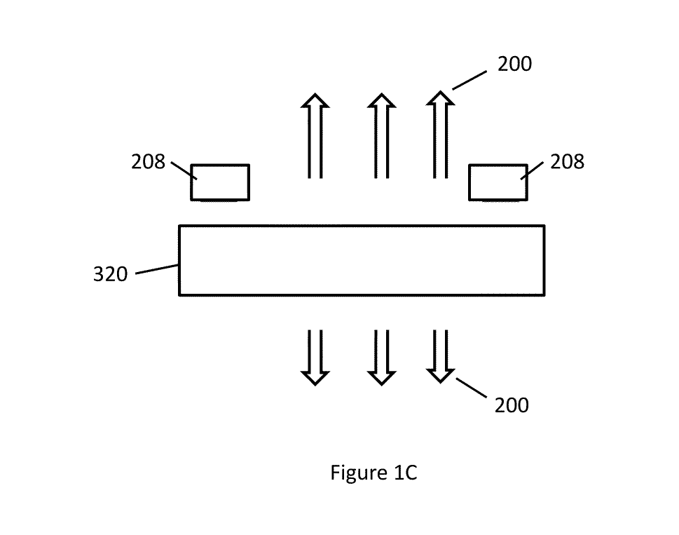

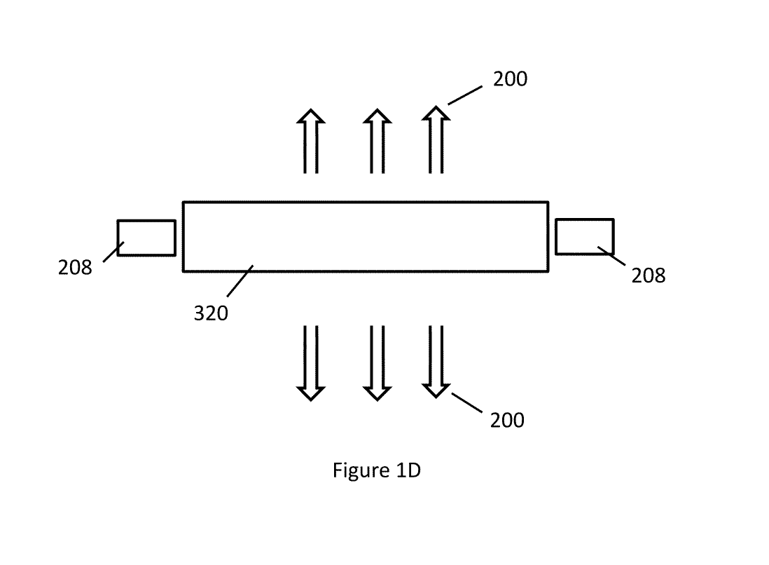

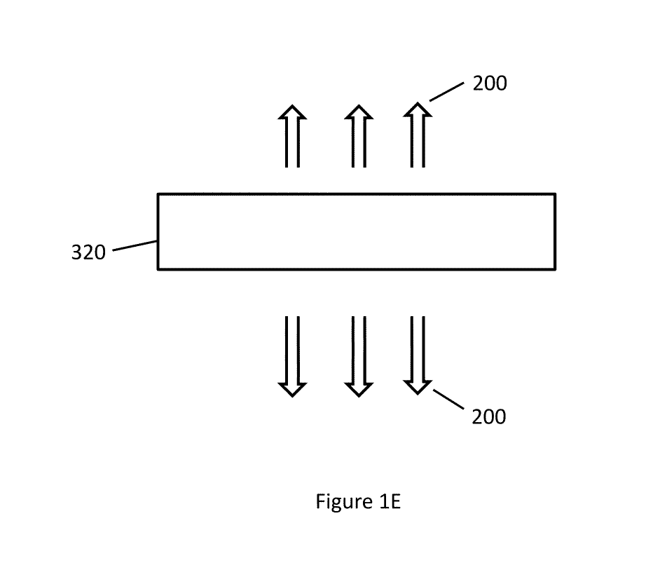

FIG. 1A shows a schematic of an illustrative embodiment where a magnetic circuit 218 is configured so that a time-varying magnetic field 200 is positioned through the depth of a microfluidic chip 320. The magnetic circuit 218 is in communication with an electrical driving circuit 208 and a time-varying voltage source 220. FIG. 1A depicts magnetic circuit 218 in communication with driving circuit 208 and microfluidic chip 320. Magnetic circuit 218 could consist of a material with high magnetic permeability, such as iron, stainless steel, and many others. FIG. 1B shows driving circuit 208 positioned to surround microfluidic chip 320. FIG. 1C shows driving circuit 208 positioned directly above and on the surface of microfluidic chip 320. FIG. 1D shows driving circuit 208 positioned adjacent to microfluidic chip 320. FIG. 1E shows time-varying magnetic field 200 positioned to extend through the depth of microfluidic chip 320.

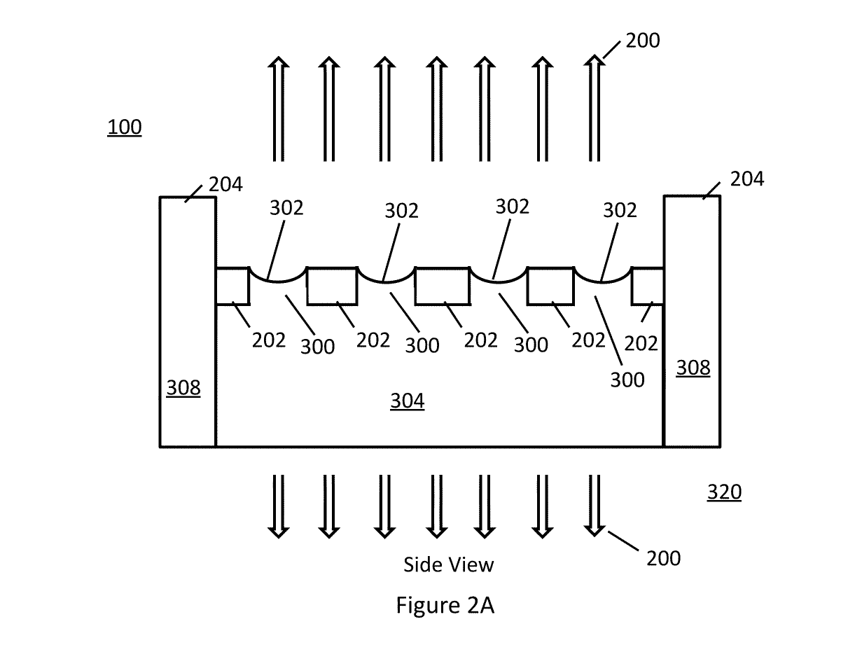

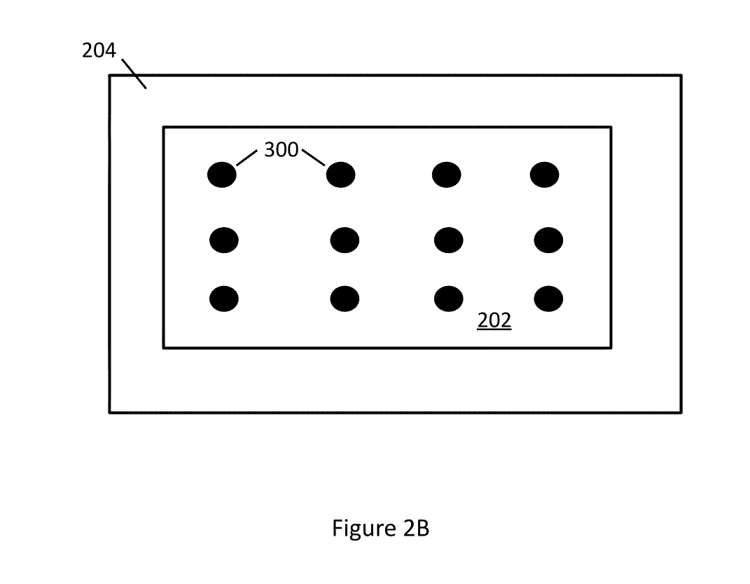

FIG. 2A shows an apparatus depicting major components of an embodiment. A time-varying magnetic field 200 is configured to extend through the depth of microfluidic chip 320. Insulator 204 surrounds the apparatus and could comprise air, or some other material. Inside insulator 204 is liquid source 304 which is in fluid communication with the at least one vaporization port 300. At least one inductive heating element 202 is in thermal communication with the at least one vaporization port 300.

In the current context, thermal communication refers to the ability to readily transfer thermal energy through heat conduction from one region of the apparatus to another region of the apparatus. In some embodiments, thermal communication occurs between two regions when the distance between those regions is substantially smaller than other dimensions in the apparatus, or the thermal conductivity of the material connecting the two regions is equal to or larger than the thermal conductivity of materials in other regions of the apparatus. In some embodiments inductive heating element 202 can be in thermal communication with at least one vaporization port 300, and/or with a thin structural region surrounding the vaporization port, because the lateral distance between the components could range between 5 um to 100 um. In some embodiments, the distance between inductive heating element 202 and vaporization port 300 could range from 0.5 um-1 mm. This distance could be substantially smaller than other dimensions of the apparatus. In an illustrative embodiment, the depth of structure 308 could range between 10 um-1000 um, and the lateral size of structure 308 could range between 1 mm-100 mm or even larger. In some embodiments, vaporization port 300 could range in size from 10 um-1 mm. In some embodiments, vaporization port 300 could range in size from 1 um-10 mm.

Inductive heating element 202 could be a metal mesh, a metal screen, a metal wool, a microfabricated plate, or some combination of these and/or other elements. In some embodiments, the metal could be a ferromagnetic material such as but not limited to: stainless steel, nickel, iron, combination, or other magnetic material. In some embodiments, the metal could be a non-ferromagnetic material. In some embodiments, the inductive heating element could be a metal substrate that is microfabricated using wet etching or dry etching to form the vaporization ports through the depth of the structure. In some embodiments, the inductive heating element could be a sintered material such as a sintered metal, a sintered material having electrical conductivity, or sintered material which is coated with an electrically conductive material. In some embodiments, the inductive heating element is substantially planar, such as a flat disk.

In some embodiments, inductive heating element 202 could be hydrophilic, which allows liquid to wet the surface, and provide excellent thermal communication between the inductive heating element 202 and liquid in vaporization port 300. Meniscus 302 separates the liquid and vapor in vaporization ports 202. The surrounding environment 100 is depicted above the apparatus.

A top view of an embodiment is shown in FIG. 2B. Electrical insulator 204 surrounds inductive heating elements 202. In an embodiment, the at least one inductive heating element 202 is in thermal communication with the at least one vaporization port 300.

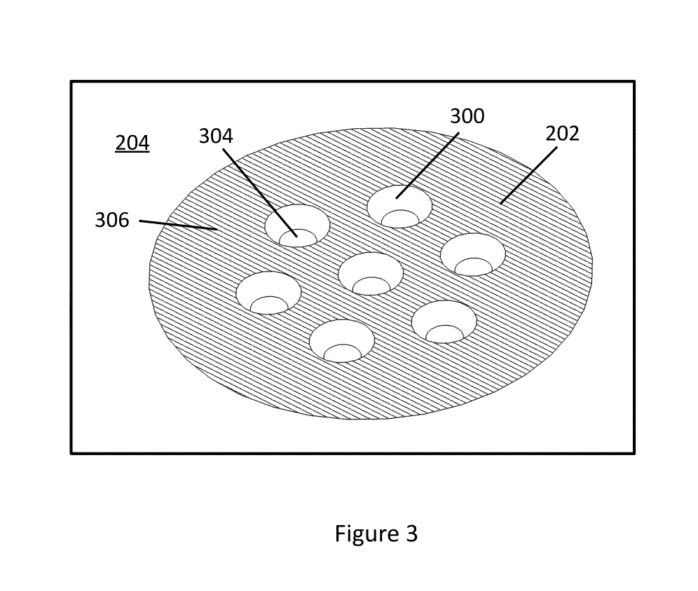

FIG. 3 shows an apparatus depicting electrical insulator 204. The at least one vaporization port 300 is in thermal communication with an at least one inductive heating element 202. A liquid source 304 is in fluid communication with the vaporization ports 300. Inductive heating element 202 is in close proximity to a thin structural region 306. This provides inductive heating in close proximity to vaporization ports 300, and minimizes thermal energy loss to the bulk substrate. In an embodiment, a cluster of multiple vaporization ports 300 could be in close proximity. The lateral dimension of the group of multiple vaporization ports could be 10 um to 10 mm, or 1 um to 100 mm.

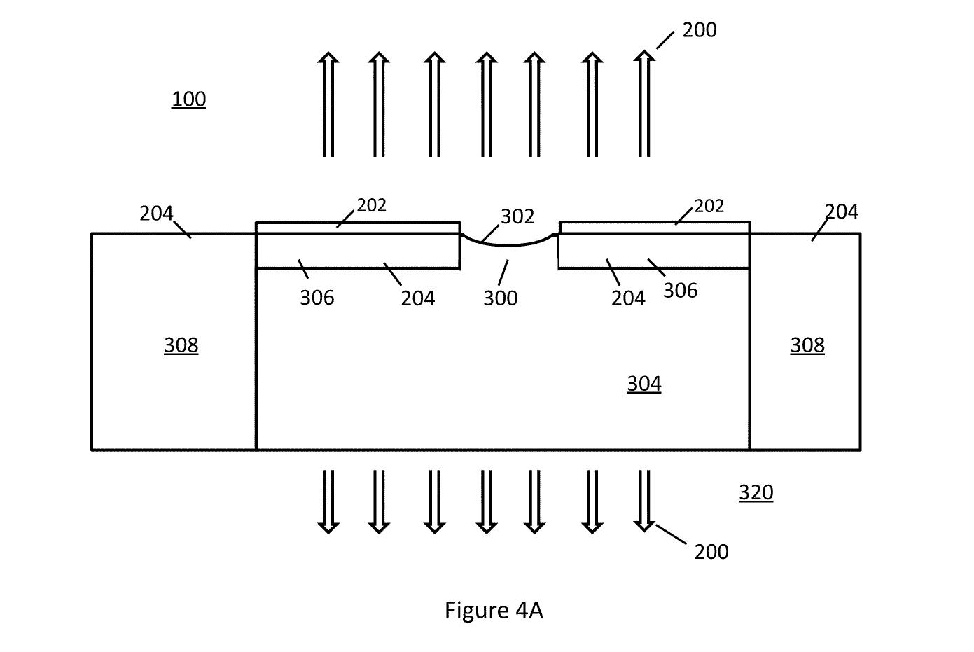

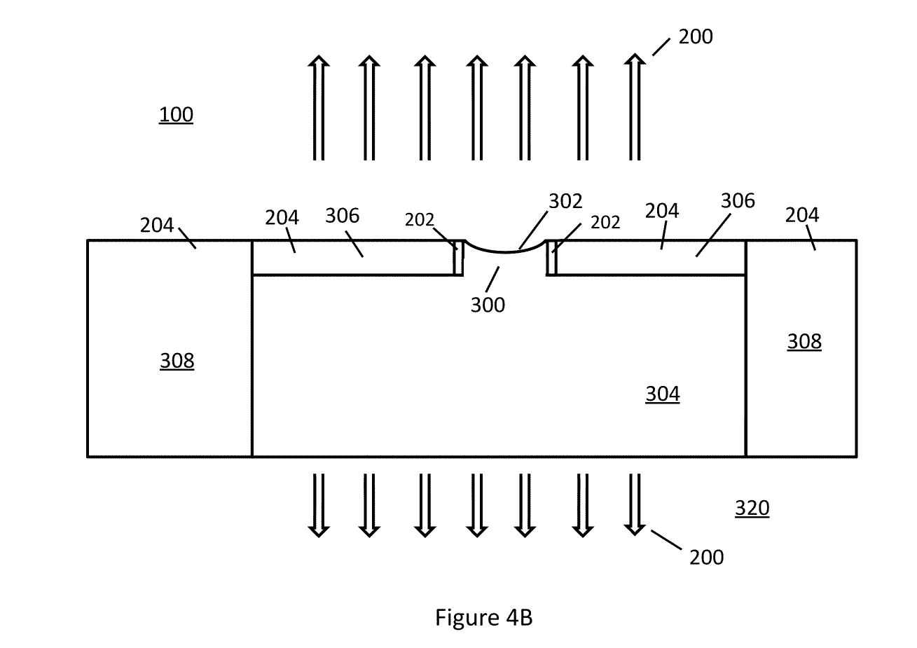

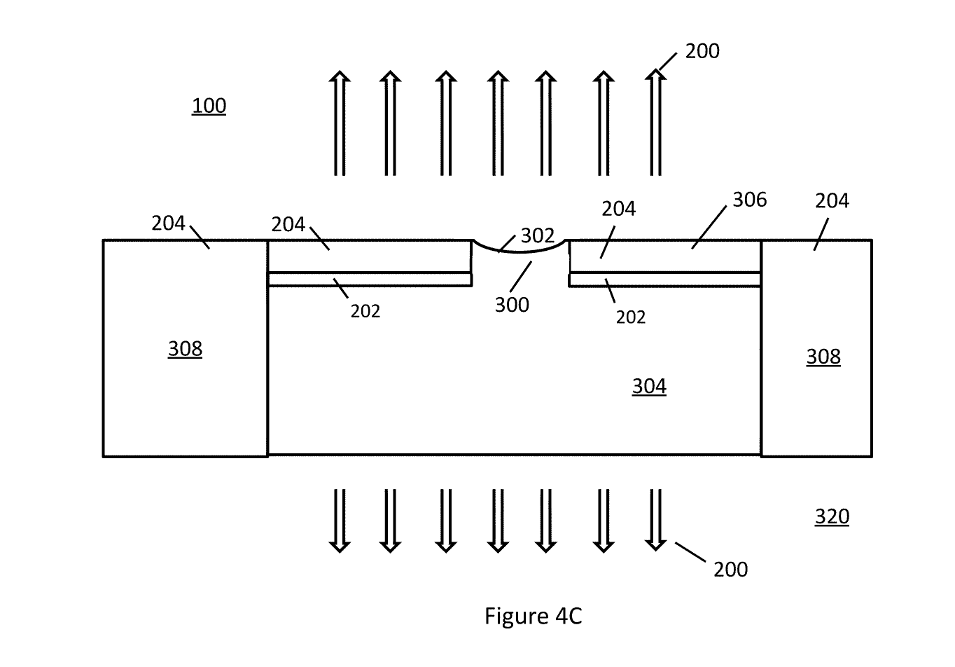

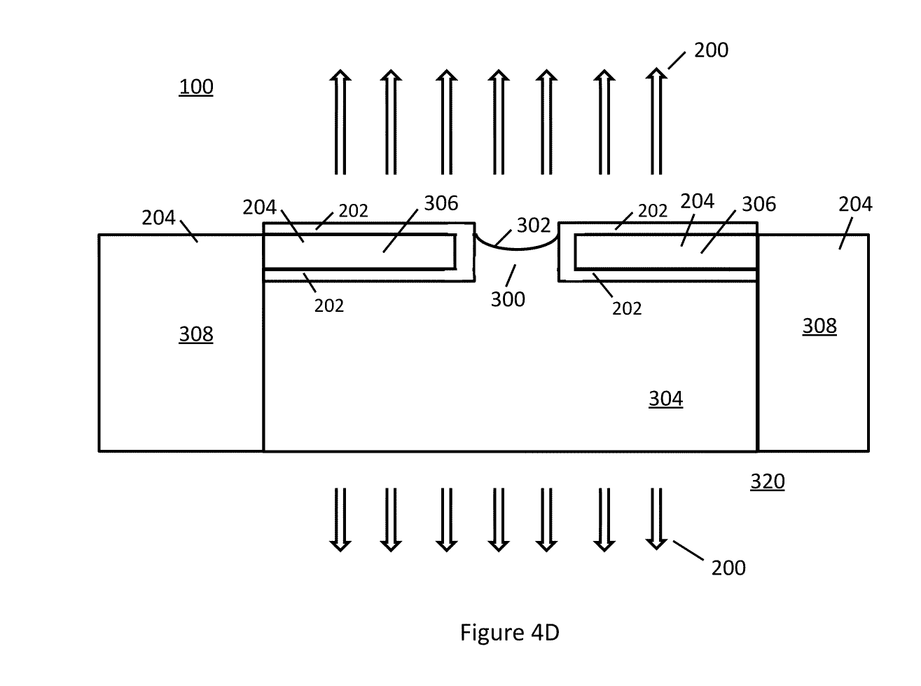

FIG. 4A shows a profile view of an apparatus formed from structure 308. Time-varying magnetic field 200 is positioned to extend through microfluidic chip 320. One or more vaporization ports 300 are in thermal communication with an at least one inductive heating element 202. Meniscus 302 separates liquid from liquid source 304 and surrounding environment 100. Electrical insulator 204 surrounds inductive heating element 202. Liquid source 304 is in fluid communication with the vaporization ports 300. Inductive heating element 202 is in close proximity to thin structural region 306. In some embodiments, thin structural region 306 and structure 308 are also electrical insulator 204. Electrical insulator 204 could be formed from glass or any other electrically insulating material. Surrounding environment 100 is above microfluidic chip 320.

In some embodiments, inductive heating element 202 could be deposited metal, or electroplated metal. In some embodiments, inductive heating element 202 could be 10 nm to 1 um in thickness. In some embodiments, inductive heating element 202 could be 100 nm to 10 um thickness. In some embodiments, inductive heating element 202 could be 10 nm to 1 mm in thickness. In some embodiments, at least one inductive heating element 202 could comprise a ferromagnetic material, such as nickel, iron, stainless steel, silicon steel, ferromagnetic alloy, and many others. In some embodiments, at least one inductive heating element 202 could comprise a non-ferromagnetic material, such as copper, gold, silver, titanium, alloy, and many others.

In an embodiment depicted in FIG. 4A, inductive heating element 202 is positioned above thin structural region 306. This could provide heating in close proximity to the vaporization port 300. In addition, this could minimize thermal energy loss to the bulk substrate.

FIG. 4B shows an embodiment where inductive heating element 202 is positioned inside vaporization port 300. In this embodiment, inductive heating element 202 is in thermal communication with the vaporization port 300. In some embodiments, inductive heating element 202 could be comprised of metal that has a thermal expansion coefficient larger than the thin structural 306 material. If inductive heating element 202 is positioned inside vaporization port 300, there could be significantly less shear stress produced between the inductive heating element 202 and the thin structural region 306, which could reduce the chances of delamination. In some embodiments, thin structural region 306 and structure 308 are also electrical insulator 204. Electrical insulator 204 could be formed from glass or any other electrically insulating material.

FIG. 4C shows an embodiment where inductive heating element 202 is positioned below thin structural region 306 and is in thermal communication with the vaporization port 300 and liquid source 304. In some embodiments this could increase the thermal energy transfer between inductive heating element 202 and the liquid source 304, and reduce thermal energy transfer to the bulk structure 308. In some embodiments, thin structural region 306 and structure 308 are also electrical insulator 204. Electrical insulator 204 could be formed from glass or any other electrically insulating material.

FIG. 4D shows the inductive heating element 202 positioned above, below, and to the side of thin structural region 306. In some embodiments this could increase the thermal energy transfer between inductive heating element 202 and liquid source 304, and reduce thermal energy transfer to bulk structure 308. In some embodiments, this configuration could decrease the chance of delamination of inductive heating element 202 and thin structural region 306. In some embodiments, thin structural region 306 and structure 308 are also electrical insulator 204. Electrical insulator 204 could be formed from glass or any other electrically insulating material.

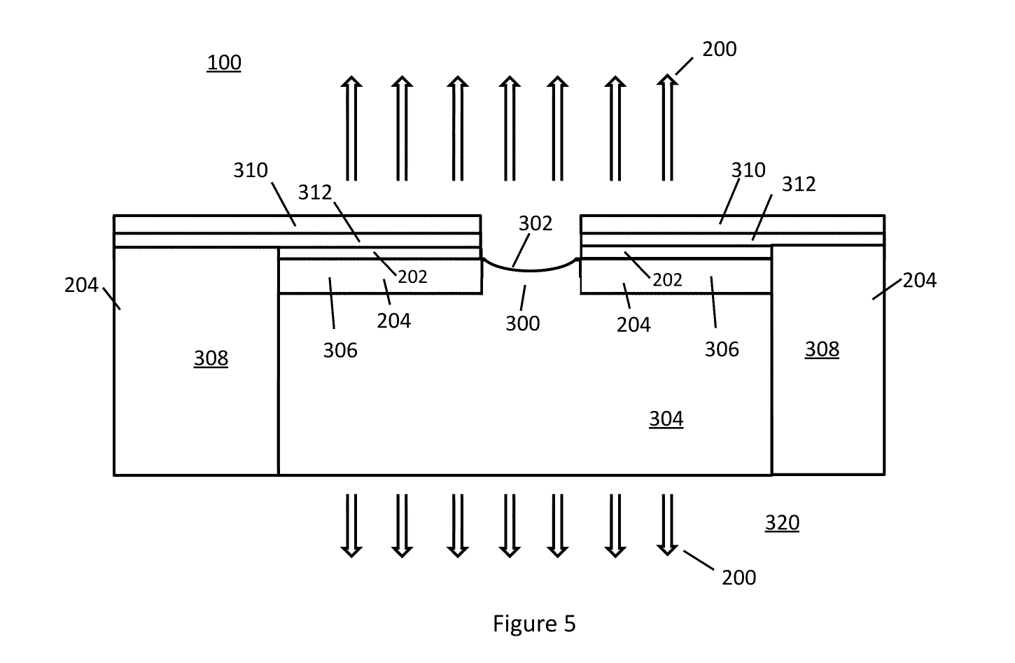

FIG. 5 shows a side view of an apparatus formed from structure 308, depicting the major components of an embodiment. Surrounding environment 100 is above the structure. Time-varying magnetic field 200 is positioned to extend through microfluidic chip 320. Meniscus 302 separates liquid from liquid source 304 and surrounding environment 100. At least one vaporization port 300 is formed in structure 308 and in fluid communication with the liquid source 304 and surrounding environment 100. FIG. 5 shows an embodiment where optionally a protective layer 312 surrounds inductive heating element 202, and optionally with a surface coating 310 that could be coated over protective layer 312 that surrounds inductive heating element 202, and could be located in close proximity to vaporization port 300. The protective layer 312 could be deposited silicone dioxide, amorphous silicon, or other material. In some embodiments, the protective layer 312 could protect at least one inductive heating element 202 from becoming delaminated, due to differences in thermal expansion between inductive heating element 202 material and the underlying thin structural 306 material. Electrical insulator 204 is in close proximity to inductive heating element 202. In some embodiments, protective layer 312 could serve as a chemical and/or electrical barrier between inductive heating element 202 and surrounding environment 100. In some embodiments, protective layer 312 could be located in close proximity to inductive heating element 202. In some embodiments protective layer 312 substantially covers thin structure 306 and/or structure 308. In an embodiment, surface coating 310 could be a hydrophobic coating. In another embodiment, surface coating 310 could be a hydrophilic coating. In another embodiment, surface coating 310 could be a combination of a hydrophobic and a hydrophilic coating. In an embodiment, a hydrophobic coating could be comprised of a fluoropolymer, or other material. In an embodiment, a hydrophobic coating could repel hydrophilic liquid and could minimize hydrophilic liquid from wetting the outside of the structure. In an embodiment, a hydrophilic coating could repel hydrophobic liquid and could minimize hydrophobic liquid from wetting the outside of the structure.

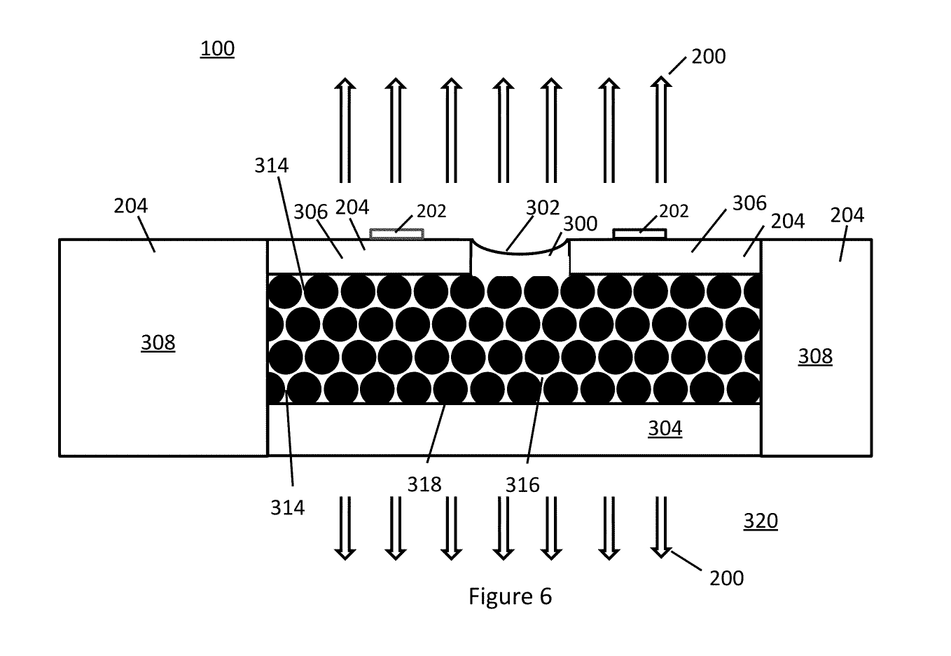

FIG. 6 shows a side view of an apparatus formed from structure 308, depicting the major components of an embodiment. Surrounding environment 100 is above the structure. Time-varying magnetic field 200 is positioned to extend through microfluidic chip 320. In some embodiments, inductive heating element 202 is located above thin structural region 306, which can provide electrical insulator 204. Meniscus 302 separates liquid from liquid source 304 and surrounding environment 100. At least one vaporization port 300 is formed in structure 308 and in fluid communication with the liquid source 304 and surrounding environment 100.

Particles or beads are located in the liquid source and optionally in the at least one vaporization port. (a) an inductive heating element is in close proximity to the vaporization port and located on an optionally thin structural region, (b) an heating element is in close proximity to the vaporization port and located on an optionally thin structural region.

In an embodiment, particles or beads 318 are located in liquid source 304 and optionally in vaporization port 300 or in close proximity to vaporization port 300. In an embodiment, particles or beads 318 may be hydrophilic. In an embodiment, hydrophilic particles or beads 318 may be formed from glass or other materials. In an embodiment, particles or beads 318 may be sintered or joined together by some other manner. In an embodiment, particles or beads 318 form small interstitial regions that enhance the effect of the hydrophilic or hydrophobic surface properties of beads or particles 318. In an embodiment, particles or beads 318 could range in size from 10 nm to 10 mm. In an embodiment, particles or beads 318 could range in size from 1 um to 1 mm. In an embodiment, particles or beads 318 could range in size from 10 um to 300 um. In an embodiment, particles or beads 318 could comprise glass or other material and could have similar coefficient of thermal expansion to thin structure region 306 material or structure 308 material. In an embodiment, particles or beads 318 could comprise a material that has a relatively high thermal conductivity, such as copper, carbon, or other material.

Liquid dryout near inductive heating element 202 could lead to excessively high temperatures that could produce undesirable chemical reactions and lead to burning of the liquid in close proximity to at least one inductive heating element 202. In an embodiment shown in FIG. 6, particles or beads 318 could be sintered and form a sintered interface 314 with narrow regions of interstitial liquid 316. The resulting structure could be superhydrophilic and could create very high surface energy and substantially increase the wettability in close proximity to at least one vaporization port 300. In some embodiments, this could substantially delay liquid dryout, and could substantially decrease excessively high temperatures and could substantially reduce undesirable chemical reactions and could substantially reduce burning of the liquid.

In an embodiment shown in FIG. 6, a superhydrophilic structure could help maintain thermal and fluid communication between at least one inductive heating element 202 and liquid from liquid source 304. In an embodiment shown in FIG. 6, a superhydrophilic structure could help maintain thermal and fluid communication between at least one inductive heating element 202 and liquid from liquid source 304, and could promote evaporation, and could reduce nucleic boiling, and could reduce burning of the liquid. In an embodiment shown in FIG. 6, at least one heating element 202 could be a source of thermal energy and could produce a temperature gradient, where the higher temperatures could be in close proximity to inductive heating element 202, and could decrease away from inductive heating element 202. This could promote evaporation near meniscus 302, and could reduce nucleic boiling, and could reduce burning of the liquid. In an embodiment shown in FIG. 6, particles or beads 318 could comprise a ferromagnetic material and could function as inductive heating element 202. In an embodiment, the particles or beads could substantially increase the surface area between the solid material and the liquid.

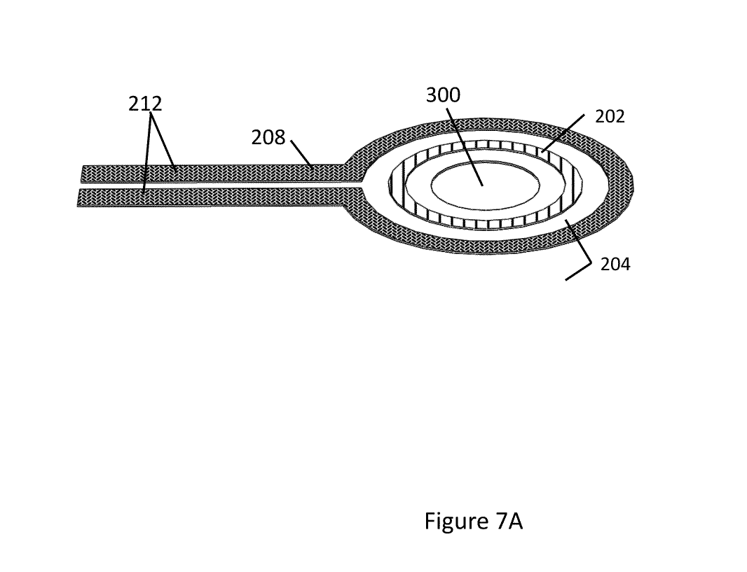

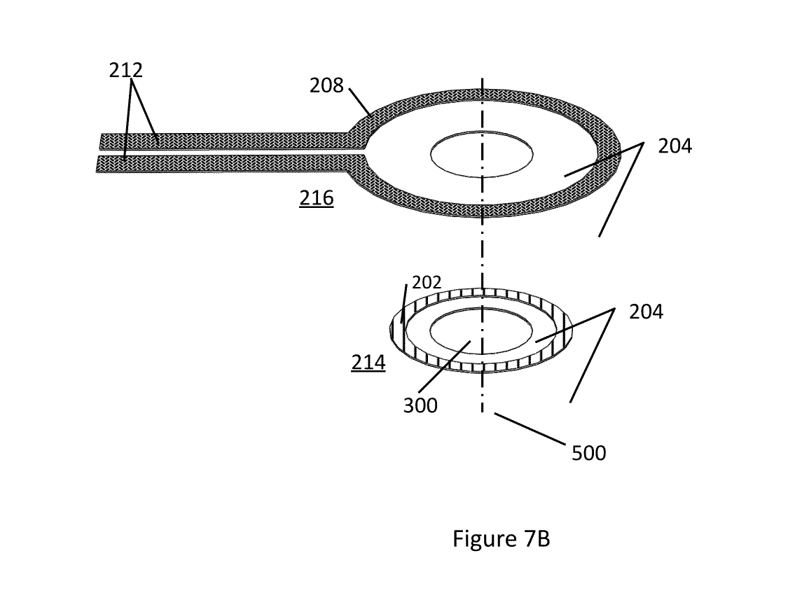

FIG. 7A shows an apparatus of an embodiment depicting electrode leads 212 that are in electrical communication with a driving circuit 208 that is separated from inductive heating element 202 by electrical insulator 204. Inductive heating element 202 is in thermal communication with vaporization port 300. Inductive heating element 202 is depicted as simply connected ring. FIG. 7A shows an embodiment where driving circuit 208 substantially surrounds inductive heating element 202. In an embodiment, inductive heating element 202 is a closed ring and is electrically insulated from driving circuit 208.

FIG. 7B shows an electrical driving circuit 208 co-axially positioned directly above inductive heating element 202, where inductive heating element 202 is on a substrate depicted as Layer 1 214, and electrical driving circuit 208 is on a second substrate depicted as Layer 2 216. Electrical insulator 204 is in close proximity to inductive heater 202. In an embodiment, electrical driving circuit 208 and inductive heating element 202 could be formed on separate substrates and could be then brought in close proximity to each other. In an embodiment, electrical driving circuit 208 and inductive heating element 202 could be co-axially aligned (as indicated by centerline 500), which could increase the magnetic coupling efficiency.

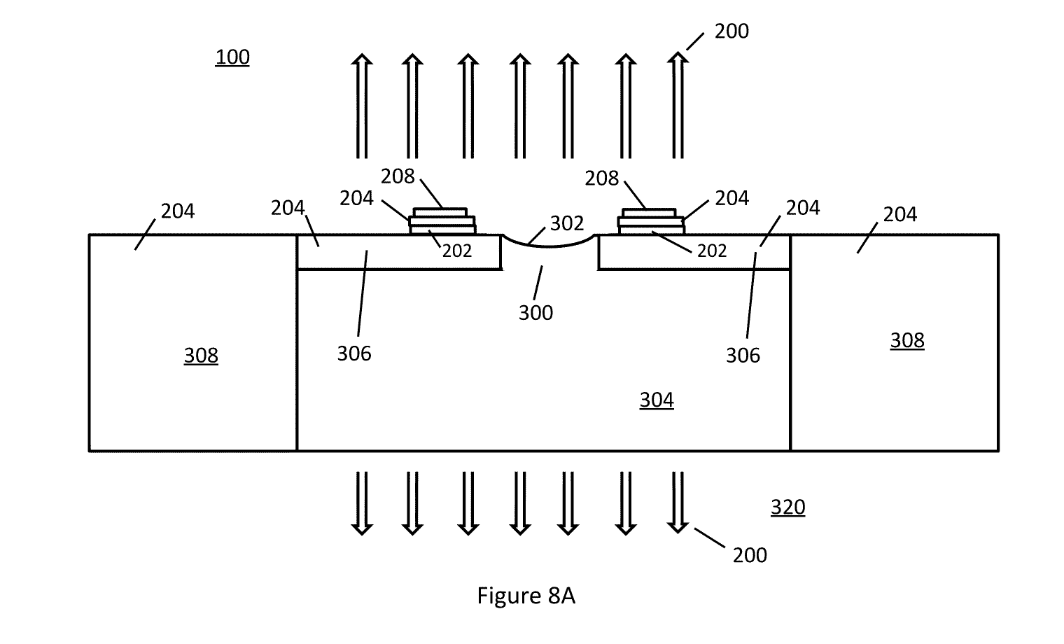

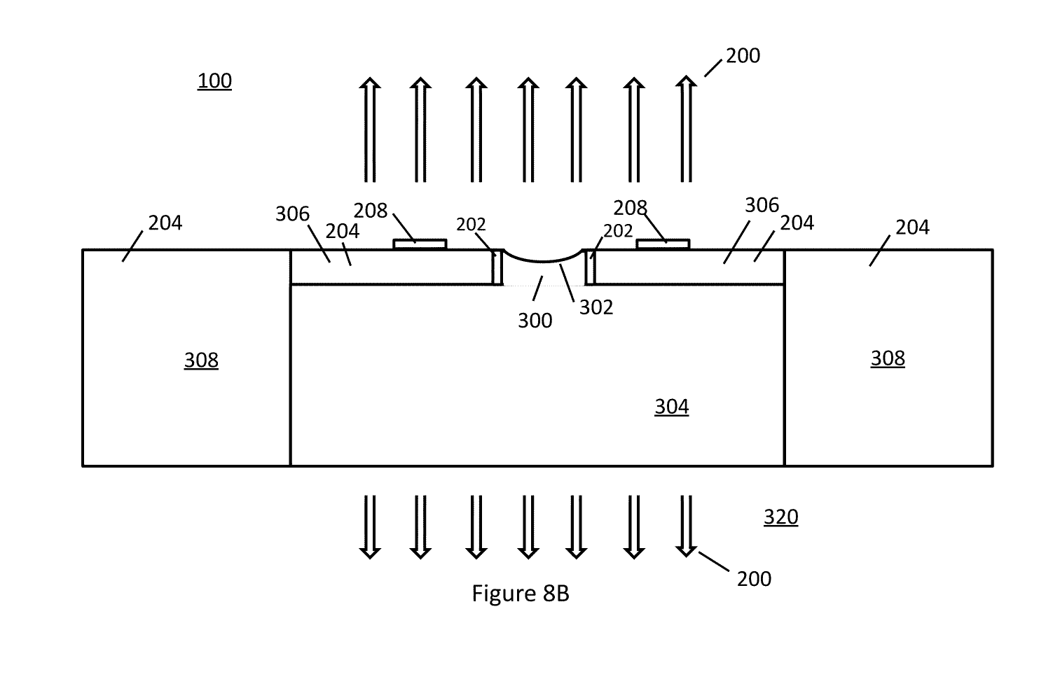

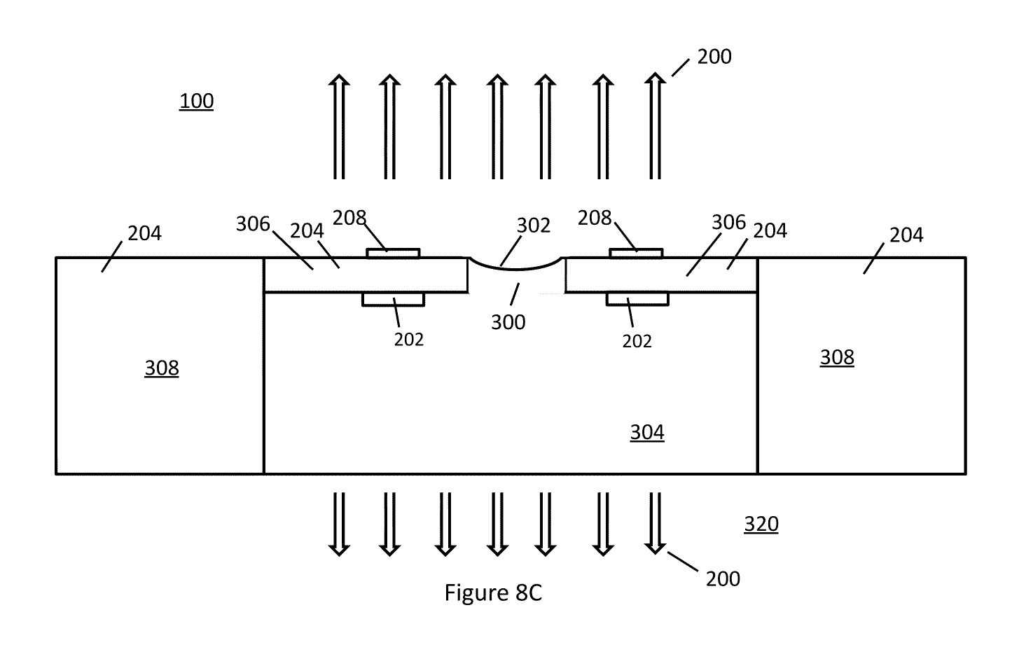

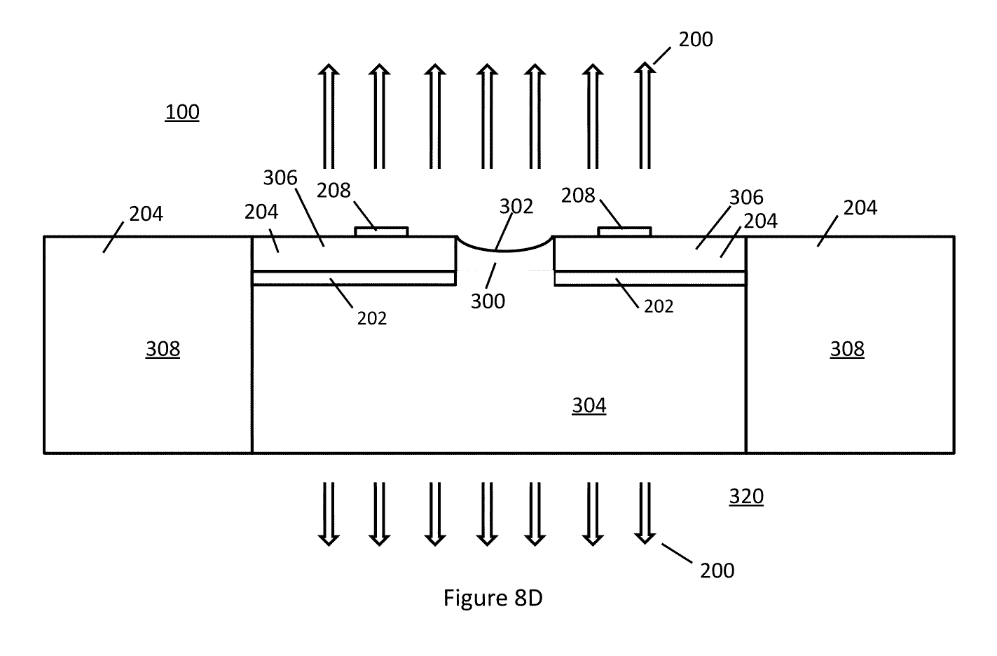

FIG. 8A shows a side view of an apparatus formed from structure 308, depicting the major components of an embodiment. Surrounding environment 100 is above structure 308. Time-varying magnetic field 200 is positioned to extend through microfluidic chip 320. Meniscus 302 separates liquid from liquid source 304 and surrounding environment 100. At least one vaporization port 300 is formed in structure 308 and in fluid communication with the liquid source 304 and surrounding environment 100. At least one vaporization port 300 is in thermal communication with at least one inductive heating element 202. Liquid source 304 is in fluid communication with at least one vaporization port 300. At least one inductive heating element 202 is in close proximity to thin structural region 306. In some embodiments, thin structural region 306 and structure 308 are also electrical insulator 204. Electrical insulator 204 could be formed from glass or any other electrically insulating material.

FIG. 8A shows an embodiment where electrical driving circuit 208 is positioned directly above inductive heating element 202 and separated by electrical insulator 204. In an illustrative embodiment, the apparatus could be microfabricated by first forming inductive heating element 202 by depositing or electroplating a metal film with or without ferromagnetic properties, such as nickel or other electrically conductive material, then depositing or electroplating electrical insulator 204, such as amorphous silicon oxide, and then by depositing or electroplating an electrically conductive layer to form electrical driving circuit 208, which could be comprised of gold, titanium, platinum, aluminum, or other conductive material.

FIG. 8B shows an illustrative embodiment where inductive heating element 202 could be positioned on the interior of vaporization port 300, and could be formed by metal deposition or electroplating. Inductive heating element 202 could be comprised of a ferromagnetic material such as nickel, or other material. In some embodiments, thin structural region 306 and structure 308 are also electrical insulator 204. Electrical insulator 204 could be formed from glass or any other electrically insulating material.

FIG. 8C shows an embodiment where inductive heating element 202 could be positioned below thin structural region 306 and is in communication with the vaporization port and the liquid source 304, and could be formed by metal deposition or electroplating. Inductive heating element 202 could be comprised of a ferromagnetic material such as nickel, or other material. In some embodiments, thin structural region 306 and structure 308 are also electrical insulator 204. Electrical insulator 204 could be formed from glass or any other electrically insulating material.

FIG. 8D shows an embodiment where inductive heating element 202 is positioned below thin structural region 306 and is in communication with the vaporization port 300 and liquid source 304. In an embodiment, inductive heating element 202 could expand substantially beyond the lateral dimension of electrical driving circuit 208. In some embodiments, thin structural region 306 and structure 308 are also electrical insulator 204. Electrical insulator 204 could be formed from glass or any other electrically insulating material.

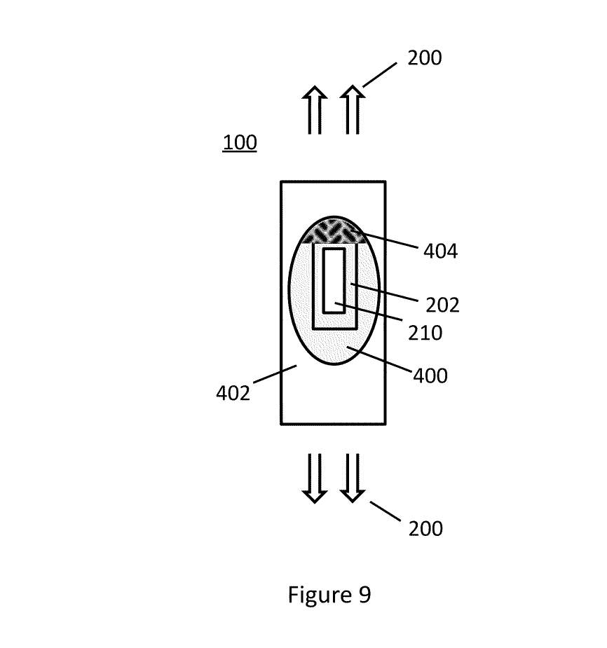

FIG. 9 shows a profile view depicting the major components of an illustrative embodiment. Surrounding environment 100 surrounds the apparatus. A containment capsule is located within the vapor routing vessel. A containment capsule 400 contains inductive heating element 202. The inductive heating element is in communication with a chemical source 210, which could be vaporized upon heating. A vapor routing vessel 402 could surround inductive heating element 202, and be in fluid communication with surrounding environment 100. Containment capsule 400 could contain an optionally removable cap 404, which could contain holes or other pass-through structures, which could allow chemical vapor to pass through the cap. Cap 404 or another region of containment vessel 400 could be covered by a possibly removable sealing mechanism, such as a tape, which could be removed by the user before use, or other means.

Containment capsule 400 could be configured to have a predetermined amount of chemical contained in chemical source 210, so as to provide a specified dose of chemical vapor. Containment capsule 400 could be configured to be disposable.

Coupling through magnetic induction could be advantageous as it can avoid complexity resulting from electrically connecting capsule 400 or microfluidic chip 320 to time-varying voltage source 220.

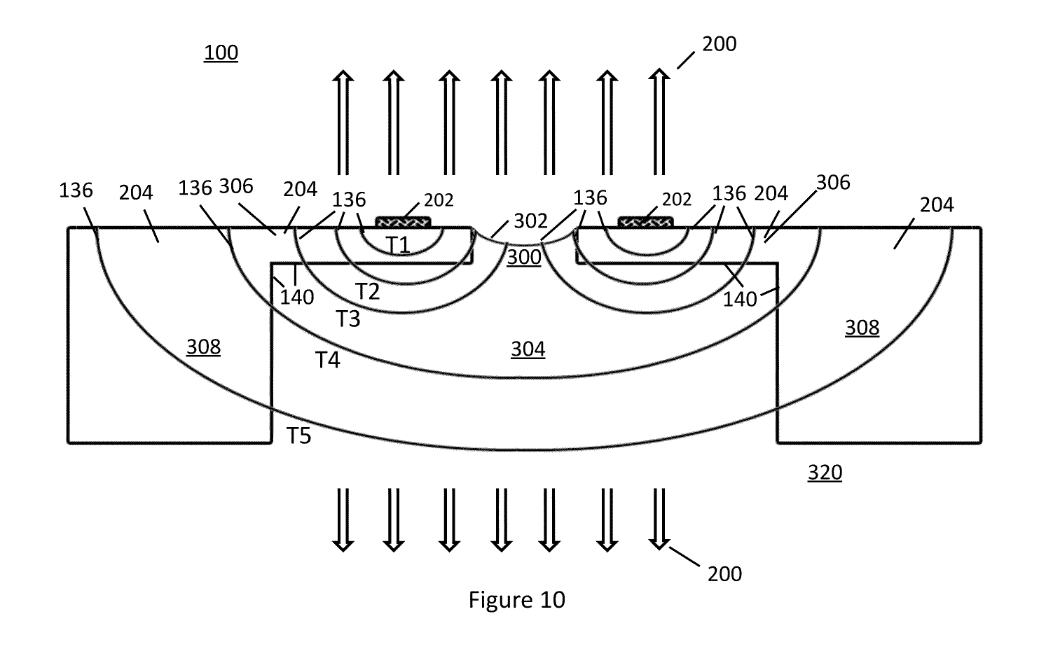

FIG. 10 shows a profile view of the apparatus depicting the various components of an illustrative embodiment. The surrounding environment 100 is above the structure 308. Time-varying magnetic field 200 is positioned to extend through microfluidic chip 320. Meniscus 302 separates liquid from liquid source 304 and surrounding environment 100. Vaporization ports 300 are formed in the structure 308 and are in fluid communication with the liquid source region 304 and the surrounding environment 100. Inductive heating element 202 is in thermal communication with the vaporization port 300 and located on a thin structural region 306. In some embodiments, thin structural region 306 and structure 308 are also electrical insulator 204. Electrical insulator 204 could be formed from glass or any other electrically insulating material. The black lines 136 depict contours on constant temperature. In some embodiments, the thin structural region 306 helps to confine thermal energy to within close proximity of inductive heating elements 202 and vaporization ports 300, and thereby reduces thermal losses to the bulk structure 308.

In some embodiments, there is significant contact surface area 140 between the thin structural region 306 and the liquid contained in a vaporization port 300 and the liquid source 304. Since liquids can have low thermal conductivity, it is important to have a large contact area 140 so that heat can be readily transferred from thin structural region 306 to the liquid. In some embodiments, thin structural region 306 may decrease the distance wherein heat may be transferred from inductive heating element 202 through thin structural region 306, before reaching the contact area 140 between thin structural region 306 and the liquid in the liquid source region 304 and vaporization port 300. In some embodiments, having a minimal distance wherein heat is transferred through thin structural region 306 may be desirable, because glass has a low thermal conductivity of approximately, k_{g}=1.05 W/(m K). Other materials such as metals, silicon, and the like provide a larger thermal conductivity, for example the thermal conductivity of silicon is approximately k_{Si}=130 W/(m K). However, in many embodiments, for thermodynamic efficiency, it is important to keep the thermal energy focused substantially to within vaporization ports 300, and therefore minimize the amount of heat that is transferred to the bulk structure 308 and surrounding environment 100. In many of these embodiments, it may be advantageous to use a low thermal conductivity material, such as a glass, a plastic, a polymer, a fiberglass, a composite, or a ceramic, and the like. In many of these embodiments, thin structural region 306, combined with a low thermal conductivity material may help to reduce parasitic heat transfer losses to the structure 308 and surrounding environment 100. In yet other embodiments, using an optimized electrical waveform may help to reduce parasitic heat transfer losses to the structure 308 and the surrounding environment 100.

The width of inductive heating elements 202 can be optionally configured with varying widths and thickness, or varying materials to produce a desired Joule heating profile. In some embodiments a desired heating profile may be chosen to provide uniform vaporization of a working fluid, while avoiding excessive heating from undesirable hot-spots. In some embodiments, 0.01 to 500 Watts of heat may be delivered to the fluid to produce vapor. In other embodiments, 1 to 50 Watts of heat may be delivered to the fluid to produce vapor.

In some illustrative embodiments, a hierarchy of inductive heating elements being connected in series/parallel configuration may have certain advantages. For example, the electrical resistance of metals can increase with increasing temperature. Therefore, if one element of a parallel circuit has a higher temperature than another element of the parallel circuit, that element could have a higher resistance and force more electrical current through the lower temperature element and thereby increase the Joule heating produced by the lower temperature element. In some embodiments, resistive heating elements connected in parallel could facilitate thermal regulation, which could help mitigate local thermal hot spots.

Joule heating from a resistive element can be described by Q=V²/R, where Q is the Joule heating power, V is the voltage drop across the resistive element and R is the electrical resistance of the element. As temperature increases, the electrical resistance of metals increases. If the voltage drop is constant, the amount of Joule heating will decrease with increasing temperature. Therefore, in an embodiment, it can be advantageous to have parallel circuits. If one branch of the parallel circuit has a higher temperature than another branch of the circuit, the branch with a higher temperature will have a higher resistance, and will therefore produce less Joule heating. In an embodiment with parallel inductive heaters, the various branches of the circuit may have self-regulating properties, that may help to regulate Joule heating that may help to maintain more uniform temperatures in comparison to the reduced uniformity which could occur using non-parallel circuit configurations.

In some embodiments, parallel inductive heating elements 202 could be configured with different resistance in each branch. In some embodiments, resistance of the inductive heating elements 202 could be modified by using different materials, different depths, different lengths, and/or different widths. In some embodiments, branches of parallel inductive heaters can have different resistances that could be optimized to produce desirable and well-controlled temperature distributions. In some embodiments, uniform temperature distributions may be desirable. In some embodiments, non-uniform temperature distributions may be desirable.

In some embodiments a hierarchical combination of parallel and series inductive heating elements 202 can be judiciously chosen to provide desired heating profiles, and self-regulating inductive heating elements 202.

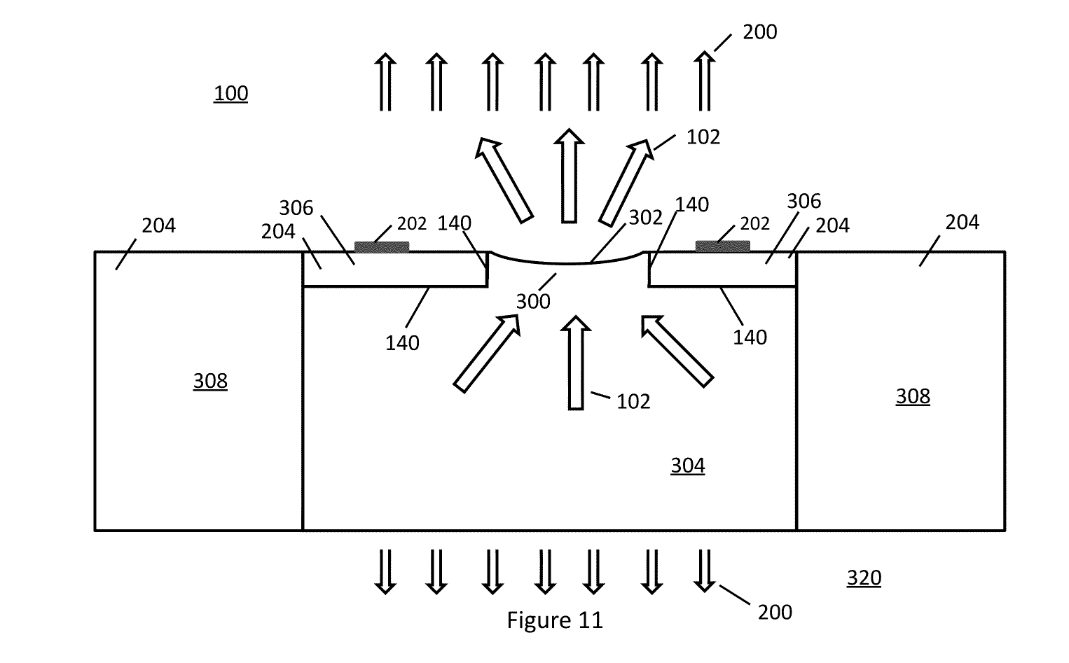

FIG. 11 refers to an illustrative embodiment where the liquid flows from the liquid source 304 region into the vaporization port 300 and is then vaporized through the meniscus 302 into the surrounding environment 100. In some embodiments, thin structural region 306 and structure 308 are also electrical insulator 204. Electrical insulator 204 could be formed from glass or any other electrically insulating material. In some embodiments, the liquid may be transported from one side (say the backside) of the microfluidic device structure 308, transported through vaporization port 300, vaporized through meniscus 302 and vapor released from the other side (say the frontside) of the microfluidic device structure 308, such that fluid is transported through the depth of the structure (i.e. though a via or through-hole). In these embodiments, the ability for liquid to travel through the device is made possible because the vaporization port 300 is in fluid communication with the liquid source 304 and the surrounding environment 100. Arrows 102 represent continuous fluid motion from one side of the structure to the other side of the structure. Arrows 102 depict continuous fluid motion of the liquid through the liquid source 304 to vaporization port 300. Arrows 102 depict continuous fluid motion of the vapor from vaporization port 300 to surrounding environment 100. The ability for fluid to be transported through the depth of the structure can make the vaporization process much more energy efficient. In some embodiments, the ability for fluid to be transported through the depth of the structure can reduce or even prevent dryout, and provide for continuous fluid motion. In some embodiments, this may allow, for example, inductive heating element 202 be placed in close proximity to vaporization port 300 for desirable thermal communication (e.g. to within 0.5 microns to 1000 microns, or 5 micron to 100 microns) to the meniscus 302, where the phase change occurs. This can dramatically reduce the distance heat must be transferred into the liquid during vaporization, and can allow inductive heating element 202 to operate at a lower temperature, compared to other vaporizer devices. This can be especially critical because most liquids have low thermal conductivity (for example the thermal conductivity of water is approximately k_{w}=0.58 W/(m K) at room temperature, the thermal conductivity of glycerin is approximately k_{w}=0.29 W/(m K)). The efficient design of these embodiments can also reduce the maximum temperature that the liquid must be exposed to during vaporization. Furthermore, in some embodiments, the more efficient design where the liquid flows through the microfluidic device may significantly reduce dryout of the liquid in the vaporization port 300, providing consistent and superior performance.

FIG. 11 depicts an illustrative embodiment where there is significant contact surface area 140 between the thin structural region 306 and the liquid contained in the vaporization port 300 and the liquid source region 304. Since liquids can have low thermal conductivity, it is important to have a large contact area 140 so that heat can be readily transferred from thin structural region 306 to the liquid. In some embodiments, thin structural region 306 may decrease the distance wherein heat may be transferred from inductive heating element 202 through thin structural region 306, before reaching the contact area 140 between thin structural region 306 and the liquid in the liquid source region 304 and vaporization port 300. In some embodiments, having a minimal distance wherein heat is transferred through the thin structural region 306 may be important, because glass has a low thermal conductivity of approximately, k_{g}=1.05 W/(m K). Other materials such as metals, silicon, and the like provide a larger thermal conductivity, for example the thermal conductivity of silicon is approximately k_{Si}=130 W/(m K). However, in many embodiments, for thermodynamic efficiency, it is important to keep the thermal energy focused in close proximity to the vaporization ports, and therefore reduce the amount of heat that is transferred to the bulk substrate and surrounding environment. In some embodiments, the thermal energy is substantially confined to vaporization ports 300. In many of these embodiments, it may be advantageous to use a low thermal conductivity material, such as, but not limited to, a glass, a plastic, a polymer, a fiberglass, a composite, or a ceramic, and the like. In many of these embodiments, thin structural region 306, combined with a low thermal conductivity material may help to minimize parasitic heat transfer losses to the bulk structure 308 and surrounding environment 100. In yet other embodiments, using an optimized electrical waveform may help to reduce parasitic heat transfer losses to the bulk structure 308 and the surrounding environment 100.

In some embodiments, glass has many features that could make it a suitable structural material for a vaporization device. For example, glass could be made durable, could be available in many geometric forms including thin wafers, could be machined, could be custom blown, shaped or molded, could be widely and commercially available, could be purchased at an affordable price, could be wet etched, could have a low electrical conductivity, could have a low thermal conductivity, could be made hydrophilic with appropriate cleaning processes, could be made hydrophobic with a judiciously chosen surface coating, surfaces could be treated with well-known surface chemistries, could be chemically inert, could be aggressively stripped of organic materials using a Piranha solution, could be mechanically stable below the glass transition temperature, metal could be deposited for electrode leads and heating elements, or could be bonded to itself or to other materials.

In some embodiments, glass could be chosen as a structural material for environmental, toxicity or health reasons. In some embodiments, the electrode leads 212 and inductive heating elements 202 could be formed from deposition and/or plating of nickel, platinum and/or titanium. Many other materials could be used for electrode and heating element deposition, such as carbon, gold, silver, nickel, aluminum, and many others. In some embodiments nickel could be a suitable material. In some embodiments, titanium could be a suitable adhesion material to provide adhesion between a glass substrate and a nickel or other metal deposited film. Other adhesion materials could also be used.

In some embodiments, inductive heating elements 202 in combination with continuous fluid motion provides steady and uniform heating of the fluid, which may keep the fluid from obtaining an undesirably high temperature, which could cause undesirable chemical by-products, or could combust, partially combust, or otherwise burn scorch, or char the liquid and the microfluidic structure 308. In some embodiments, the continuous fluid motion may provide for a steady operation that may allow the apparatus to continuously function for indefinite periods of time, while minimizing potentially undesirable ramifications, such as liquid dryout, undesirable chemical by-products, scorching or combusting of the liquid, or scorching or combusting of the apparatus.

In some embodiments, vaporization could occur in discrete time periods ranging from a few milliseconds to tens of seconds, or longer. In some embodiments, vaporization could occur in discrete time periods ranging from a few milliseconds to tens of seconds, or longer, to provide precision delivery of vapor mass for accurate dosing.

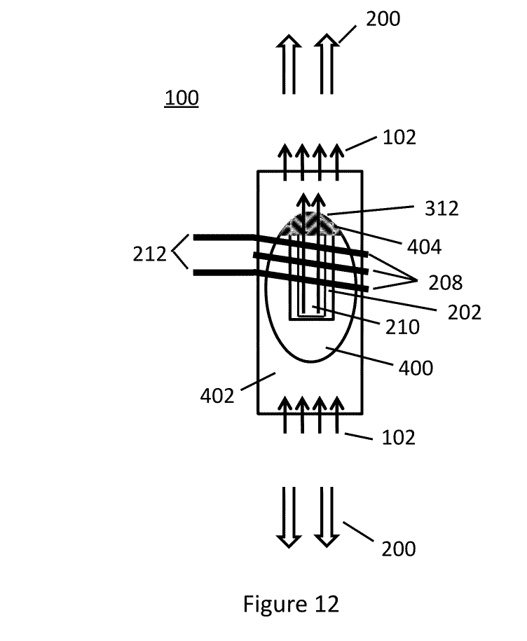

FIG. 12 shows an embodiment where the containment capsule 400 could provide a sealed compartment inside where an inductive heating element 202 and a chemical source 210 could be located. An electrical driving circuit 208 could be energized using electrical leads 212, to produce a time-varying magnetic field 200. The time-varying magnetic field 200 can be configured to extend through containment capsule 400. Containment capsule 400 could provide a means to store a particular quantity of a particular substance for a long period of time, which could be vaporized by the apparatus. Capsule 400 could block diffusion of air and other contaminant gases to the chemical source, and could protect chemical source 210 from unwanted diffusion from within containment capsule 400 or from surrounding environment 100. In an embodiment, optional removable cap 404 could be used to seal the chemical and then could be removed to allow chemical source 210 to vaporize from within containment vessel 400. Vaporization of chemical source 210 could be driven by heating occurring by at least one inductive heating element 202. The optional removable cap 404 or a portion of containment capsule 400 could contain at least one hole or other means to allow transport of chemical source 210 to surrounding environment 100. In an embodiment, the at least one hole could be blocked by a removable protective layer 312 such as a tape strip or by a switchable flow-blocking mechanism, which could be activated or optionally deactivated by the user to allow chemical source 210 to exit the containment capsule 400 after some period of storage. Air could be added into the air inflow or vacuum added to the outflow and could aid in convection of vapor produced from the containment capsule 400.

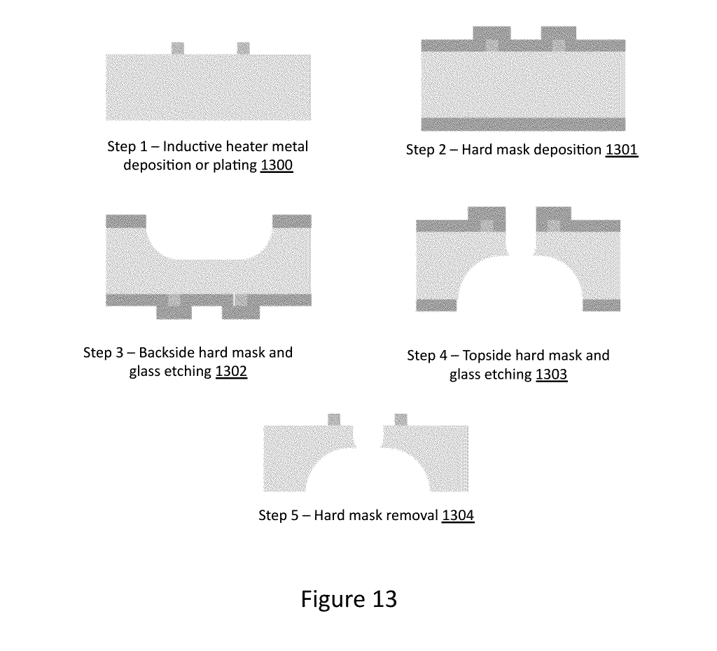

FIG. 13 shows an example for a microfabrication process flow for device fabrication for an embodiment, which consists of five processing steps using a single structure. In an illustrative embodiment, the structure 308 could be made from a 300 μm thick glass substrate from Schott (D263T-eco, AF32-eco or MEMpax). The glass substrate could be formed from a variety of materials and thicknesses ranging from 1 um to 10 mm. A photoresist could be patterned and metal (for example, nickel, nickel alloy, titanium and platinum) could be deposited or electroplated to for the inductive heating elements (Step 1—Inductive heater metal deposition or plating 1300). After photoresist and metal liftoff, a hard mask film (for example, chromium/gold, aluminum or amorphous silicon) could be deposited on both sides of the substrate (Step 2—Hard mask deposition 1301). On the backside, photoresist could be patterned and the hard mask could be etched (wet or dry) followed by the glass being optionally wet etched down to roughly half the substrate thickness (Step 3—Backside hard mask and glass etching 1302). On the frontside, the vaporization port 300 could be patterned in close proximity (which could range between 5 um to 100 um, or 0.5 um to 1 mm) to inductive heating element 202 and a hard mask could be etched, followed by optional wet etching of the glass. At the same time, the backside could optionally be further etched since it could optionally be exposed, and a via (or through hole) could be created (Step 4—Topside hard mask and glass etching 1303). This could allow vaporization port 300 to be in fluid communication with the liquid source 304 and the surrounding environment 100. Finally, the hard mask could be removed from both sides, and the substrate could then be diced (Step 5—Hard mask removal 1304).

A variety of nanofabrication and microfabrication equipment could be used to fabricate some embodiments of the vaporization device. The fabrication may include numerous deposition tools such as electron beam deposition, which could be used for the heating element, and plasma enhanced chemical vapor deposition (PECVD), which could be used to deposit the hard masks. In some embodiments, wet chemistry benches could be used for a variety of etch chemistries, including hydrofluoric acid etching of glass. Dry etching could also be used for isotropic etches in certain materials such as inductively coupled plasma reactive ion etching (ICP-RIE). Furthermore, in some embodiments, a photolithography mask aligner capable of backside alignment, such as the SUSS MA-6, could be used to pattern and align the features from front to back.

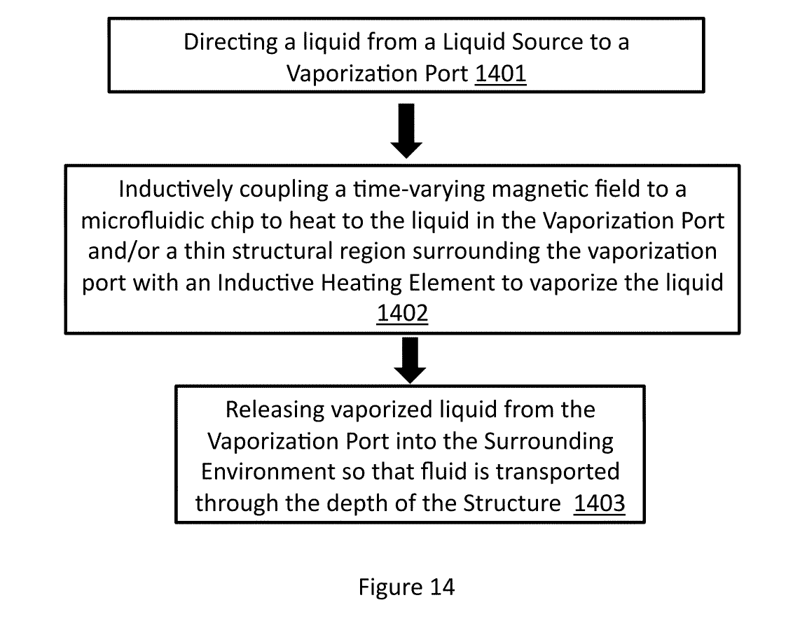

FIG. 14 shows a flowchart depicting a method of an embodiment, which involves directing a liquid from a liquid source to a vaporization port 1401, and inductively coupling a time-varying magnetic field to a microfluidic chip to heat the liquid in the vaporization port and/or a thin structural region surrounding the vaporization port with an inductive heating element located in close proximity to the vaporization port to vaporize the liquid 1402 (which could range between 5 um to 100 um, or 0.5 um to 1 mm). In an embodiment, the vaporized liquid is released from the vaporization port into the surrounding environment so that fluid is transported through the depth of the structure 308. In some embodiments, the vaporization port 300 has lateral dimensions ranging from 10 um-300 um. In yet other embodiments, the vaporization port has lateral dimensions ranging from 1 um-1000 um. Liquid could be introduced to the liquid source by directly placing the liquid in the liquid source or by an optional pump or an optional wicking structure wherein the liquid could be transported through capillary action to the liquid source. In an embodiment, electrical energy could be applied to the heating element, and the heating element could be heated through Joule heating (i.e. resistive heating). The thermal energy from the heating element could then be transferred to the thin structural region, which is adjacent to the vaporization port and liquid source. Heat could then be conducted locally into the liquid to heat the liquid to an optimal temperature for vaporization. This temperature could be well controlled so that the liquid is heated sufficiently for vaporization, but does not reach an undesirably high temperature, which could cause undesirable chemical reactions or dryout the vaporization port. In addition, by controlling the electrical energy to the heating elements, the rate of vaporization or the total mass of vaporization can be accurately controlled. In some embodiments, the amount of electrical energy could be optionally varied, and optimized for the specific application. In yet other embodiments, an electrical waveform could be sinusoidal, square wave, or other waveform, which could be optimized for the specific application. In yet other embodiments, the waveform could pulse and cause vaporization, an aerosol or ejections of liquid droplets, and could decrease parasitic heat loss, thereby increasing thermodynamic efficiency.

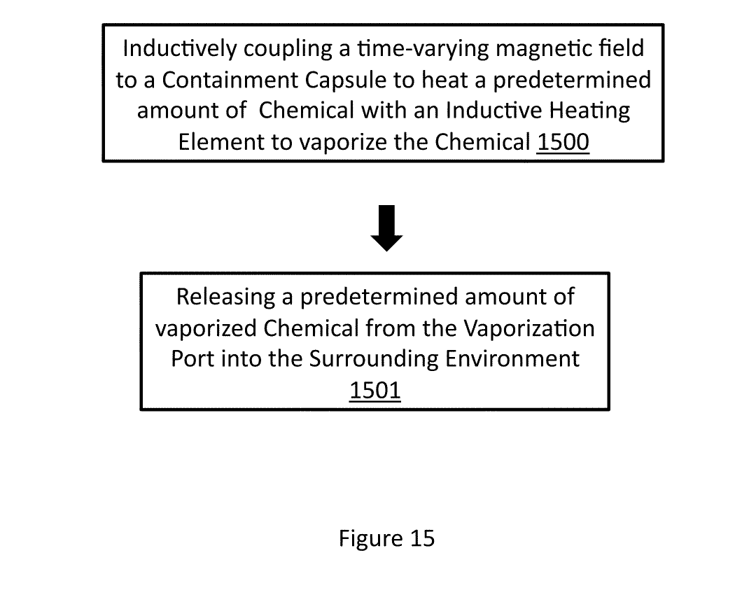

FIG. 15 shows a flowchart depicting a method of an embodiment, which involves inductively coupling a time-varying magnetic field to a containment capsule to heat a predetermined amount of chemical with an inductive heating element to vaporize the chemical 1500, and releasing a predetermined amount of vaporized chemical from the vaporization port into the surrounding environment 1501.

The embodiments described herein are exemplary. Modifications, rearrangements, substitute processes, materials, etc. may be made to these embodiments and still be encompassed within the teachings set forth herein.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list

Disjunctive language such as the phrase “at least one of X, Y or Z,” unless specifically stated otherwise, is otherwise understood with the context as used in general to present that an item, term, etc., may be either X, Y or Z, or any combination thereof (e.g., X, Y and/or Z). Thus, such disjunctive language is not generally intended to, and should not, imply that certain embodiments require at least one of X, at least one of Y or at least one of Z to each be present.

The terms “about” or “approximate” and the like are synonymous and are used to indicate that the value modified by the term has an understood range associated with it, where the range can be ±20%, ±15%, ±10%, ±5%, or ±1%. The term “substantially” is used to indicate that a result (e.g., measurement value) is close to a targeted value, where close can mean, for example, the result is within 80% of the value, within 90% of the value, within 95% of the value, or within 99% of the value.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “an element configured to carry out recitations A, B and C” can include a first element configured to carry out recitation A working in conjunction with a second elements configured to carry out recitations B and C.

While the above detailed description has shown, described, and pointed out novel features as applied to illustrative embodiments, it will be understood that various omissions, substitutions, and changes in the form and details of the devices or methods illustrated can be made without departing from the spirit of the disclosure. As will be recognized, certain embodiments described herein can be embodied within a form that does not provide all of the features and benefits set forth herein, as some features can be used or practiced separately from others. All changes which come within the meaning and range of equivalency of the claims are to be embraced within their scope.

What is claimed is:

1. A vaporization apparatus that is placed within a surrounding environment and configured to vaporize liquid into the surrounding environment, comprising;
at least one liquid source;
at least one vaporization port that is formed in a structure, with lateral dimensions ranging from 10 um to 300 um, that is in fluid communication with the liquid source and the surrounding environment so that fluid is transported through the depth of the structure;
at least one driving circuit;
at least one inductive heating element that is in thermal communication to the at least one vaporization port.

2. Apparatus of claim 1, wherein the fluid communication between the liquid source and the surrounding environment occurs throughout the depth of the apparatus.

3. Apparatus of claim 2 wherein the structure comprises a thin structural region, with a thickness varying from 1 um to 100 um.

4. Apparatus of claim 3, wherein a protective layer is formed on the structure that surrounds the heating element.

5. Apparatus of claim 4, wherein the protective layer comprises deposited glass.

6. Apparatus of claim 3, wherein a surface coating is formed on the structure but masked from forming on the walls of the vaporization ports.

7. Apparatus of claim 6, wherein the surface coating comprises fluoropolymers.

8. Apparatus of claim 4, wherein a surface coating is formed on the structure but masked from forming on the walls of the vaporization ports.

9. Apparatus of claim 2, wherein at least one of a bead or particle wicking structure is located in at least one of the liquid source region of the structure or within the ports.

10. Apparatus of claim 9, wherein at least one of the beads or particles have dimensions of 10 um to 300 um.

11. Apparatus of claim 10, wherein at least one of the beads or particles are comprised of a hydrophilic surface.

12. Apparatus of claim 11, wherein at least one of the beads or particles are sintered.

13. Apparatus of claim 12, wherein at least one of the beads or particles are comprised of glass.

14. Apparatus of claim 2, wherein the inductive heating element is a thin-film resistive heating element.

15. Apparatus of claim 14, wherein the resistances of the inductive heating elements are varied to provide a controlled thermal distribution.

16. Apparatus of claim 15, wherein the inductive heating elements, are electrically connected in parallel and series combination.

17. A method for vaporizing liquid into the surrounding environment, comprising;
directing liquid from a liquid source to at least one vaporization port, wherein the vaporization port has lateral dimensions varying from 10 um to 300 um;
inductively coupling a time-varying magnetic field to a microfluidic chip to apply heat to the liquid in at least one of the vaporization port or in contact with a thin structural region with at least one inductive heating element located in thermal communication to at least one of the vaporization port or the thin structural region, and;
releasing vaporized liquid from the vaporization port into the surrounding environment so that fluid is transported through the depth of the structure.

18. Method of claim 17, wherein during operation, liquid continuously flows from the liquid source to the vaporization port, changes phase from liquid to vapor, and the vapor continuously flows from the vaporization port to the surrounding environment.

19. Method of claim 18, wherein the thin structural region substantially confines thermal energy to the heating element and vaporization port.

20. Method of claim 19, wherein the thin structural region reduces thermally-induced stresses that occur in the heating element and the vaporization port.
